(19) United States
(12) Patent Application Publication
(10) Pub. No.: US 2007/0184165 A1
(43) Pub. Date: Aug. 9, 2007

(54) Compositions and methods for improving the efficiency of preservatives in foods

(75) Inventors: Rina Reznik, Ra'anana (IL); Boris Herskowitz, Nahariya (IL)

Correspondence Address: STITES & HARBISON PLLC, 1199 NORTH FAIRFAX STREET, SUITE 900, ALEXANDRIA, VA, 22314, US

(73) Assignee: RAD NATURAL TECHNOLOGIES LTD., Petach Tikva (IL)

(21) Appl. No.: 10/566,754

(22) PCT Filed: Aug. 3, 2004
(86) PCT No.: PCT/IL04/00713

§ 371 Date: Jul. 24, 2006

(30) Foreign Application Priority Data
Aug. 4, 2003 (IL) 157234

(51) Int. Cl. C11B 5/00

(52) U.S. Cl. 426/541

(57) ABSTRACT

The invention relates to a composition which comprises component (1) and at least one of components (2), (3) and (4): (1) a completely water-soluble antioxidant which is a Labiatae tissue extract containing sodium rosmarinate; (2) ascorbic acid, isoascorbic acid and (or) their non-toxic water-soluble salts in a weight ratio to sodium rosmarinate of 1.5:1 to 90:1; (3) citric acid, its non-toxic salts, and (or) non-toxic water soluble salts of acetic and (or) lactic acids; (4) at least one non-toxic salt of propionic acid. Embodiments of such compositions are useful for enhancing the antioxidative protection afforded to meat products, or to edible oils or fats (or foodstuffs containing them), and for enhancing inhibition of microbial deterioration in foodstuffs provided by the acids and salts specified in ingredients (3) and (4).

### FIELD OF THE INVENTION

The present invention relates to a completely water-soluble antioxidant, containing sodium rosmarinate, which is an extract of plant tissue of the Labiatae family, in combination with specific food additives having antioxidant and/or antimicrobial activity, and to methods for enhancing the effectiveness of such additives.

### BACKGROUND OF THE INVENTION

U.S. Pat. No. 6,383,543, having the same inventor as the invention of the present application, in connection with the discovery that the sodium salt of rosmarinic acid existed in, and could be directly extracted from, tissue of plants of the Labiatae family, describes and claims inter alia a process for the extraction of completely water-soluble antioxidant material comprising this salt from such tissue.

Both U.S. Pat. No. 6,383,543, and U.S. patent application Ser. No. 10/168,488, having the same inventor as the invention of the present application, disclose use as an antioxidant for a substance liable to oxidative deterioration, of (inter alia) sodium rosmarinate isolated from tissue of plants of the Labiatae family, by use of an aqueous extractant. In U.S. Ser. No. 10/168488, the antioxidant constitutes, for example, about 0.0001 to about 1.0% by weight of said substance.

Carboxylic acids have a long history of use in food preservation. Thus, in U.S. Pat. No. 4,476,112 (Aversano), it was proposed to use a combination of ascorbic and citric acids (or their sodium or potassium salts), sodium or potassium carbonate and sodium or potassium sulfite, bisulfite or metabisulfite, to preserve the color and freshness of meat, poultry, fruit and vegetables. In U.S. Pat. No. 4,590,079 (Nishimori et al.), it was proposed to prevent discoloration of meat products by incorporating therein ascorbic acid, cystine or cysteine and aspartic acid, and optionally a starch hydrolyzate. In U.S. Pat. No. 4,818,548 (Cheng), it was proposed to preserve the color of fresh meat cuts by treating with a combination of ascorbic acid or an ascorbate, citric acid or a citrate, and a phosphate. Moreover, citrates per se have been used to prohibit bacterial growth in meat, see e.g. U.S. Pat. Nos. 5,302,406 and 5,436,017.

Furthermore, in U.S. Pat. No. 4,146,651 (Bharucha et al.) it is mentioned in the background that ascorbic acid, erythorbic acid and certain salts and esters thereof have been investigated for their effect in inhibiting the formation of toxic nitrosamines in e.g. fried or cured meats, while this patentee proposes new acetals and ketals of ascorbic acid for this purpose.

However, ascorbic acid is itself unstable and liable to degradation. It is also known that under certain conditions ascorbic acid or its degradation products can act as pro-oxidants rather than as antioxidants. There is thus a hitherto unfulfilled need in the art to improve the performance of ascorbic acid as an antioxidant in the food industry and especially in the meat industry.

U.S. Pat. No. 6,099,879 (Todd, Jr.) describes and claims a method for reducing the development of radiation induced off-flavors and aromas, delaying the onset of oxidative rancidity during storage, retarding development of meat flavor deterioration or warmed-over flavor upon cooking and reheating, and for preserving the flavor of seasonings present, in meat or a meat product which is treated with ionizing radiation, comprising the step of incorporating in the meat or meat product prior to irradiation, a stabilizing amount of rosemary extract or an active antioxidant ingredient thereof (specifically, carnosic acid, carnosol and/or rosmarinic acid), optionally with the addition of tocopherols, ascorbic acid, citric acid, or sodium tripolyphosphate. The rosemary extract is essentially an oily extract, preferably an oleoresin from which some of the volatile oil has been removed. Exemplary combinations of ingredients are 0.2% rosemary extract+0.25% sodium tripolyphosphate, or rosemary extract 2000 ppm+ascorbic acid 200 ppm+citric acid 50 ppm+tocopherol 200 ppm.

In addition to the need for effective antioxidants in the food industry, there is a parallel need for preservative and/or antimicrobial substances. This need has been met to some extent by the use of water soluble salts, such as the sodium and potassium salts, of acetic and lactic acids. Thus, JP 59-175870 published Oct. 4, 1984, proposes preserving a variety of processed foods by a combination of glycine with such acetate and/or lactate. JP 61-239865 published Oct. 25, 1986, proposes improving the taste quality of fish and meat paste by a mixture of a brewed vinegar with sodium acetate. JP 11-000133 published Jan. 6, 1999, proposes improving the keeping quality, flavor and texture of processed meat by including in the product sodium lactate and sodium acetate, and optionally sodium citrate. JP 11-221065 published Aug. 17, 1999, proposes improving the long-term prevention of deterioration in a fish or meat product by use of a combination of sodium acetate, acetic acid and diglycerin mono-fatty acid ester. U.S. Pat. No. 5,989,610 (Ruzek) proposes enhancing visual appeal and shelf-life of fresh meat by including therein a lactate buffer (e.g. sodium lactate) and a diacetate microbial growth inhibitor (e.g. CH₃CO₂Na. CH₃CO₂H). It would evidently be a useful addition to the art to improve the performance of such preservatives/antimicrobials, preferably while providing simultaneous antioxidant protection.

Additionally, propionates are used to reduce mold formation in foods, especially in the bakery industry, see e.g. the dusting powder applied to cooking or baking, of U.S. Pat. No. 4,407,839 which mentions use of calcium and sodium propionates, and the method of inhibiting microorganism growth in foodstuffs, using ammonium, sodium, potassium, calcium or magnesium acid propionates.

The entire contents of the above-mentioned patents and patent applications, and of the references recited these documents, are incorporated by reference herein.

### OBJECTS OF THE INVENTION

It is a general object of the invention to improve the performance of food additives, and especially such additives which contribute to maintained taste, color and freshness of the foods to which the additives are added.

A more particular object of the invention is to enhance the performance in foods of a particular group of antioxidants, and of a particular group of preservatives/antimicrobials.

Another object of the invention is to employ a naturally occurring substance in order to achieve the performance-enhancement purposes of the invention.

Other objects of the invention will be understood from a description of the invention which follows.

### SUMMARY OF THE INVENTION

The present invention provides in one aspect, a composition which comprises component (1) and at least one of components (2), (3) and (4), namely:
(1) a completely water-soluble antioxidant containing sodium rosmarinate which is an extract of plant tissue of the Labiatae family; (2) at least one ingredient selected from ascorbic acid, isoascorbic acid, and their non-toxic water-soluble salts; (3) at least one ingredient selected from citric acid and its non-toxic salts, and non-toxic water soluble salts of acetic and lactic acids; (4) at least one ingredient selected from non-toxic salts of propionic acid; provided that when component (2) is present, the weight ratio of sodium rosmarinate to component (2) is within the range of about 1:1.5 to about 1:90, preferably about 1:3 to about 1:50.

This composition may be in the solid state, e.g. for storage or transportation purposes, but it will normally be used in the liquid state, e.g. as an aqueous solution comprising components (1) and (2); or as an emulsion comprising components (1) and (2), together with water and at least one non-toxic oil and at least one non-toxic emulsifying agent; or as an aqueous solution comprising components (1) and (3). Solid or liquid admixtures of components (1) and (4) are of course part of the present invention.

More generally, the present invention provides a method for enhancement of the preservative activity in a foodstuff of a known additive selected from the group consisting of carboxylic acids and non-toxic salts thereof, which comprises adding to the foodstuff, in addition to said known additive, a completely water-soluble antioxidant extract of plant tissue of the Labiatae family containing sodium rosmarinate, in an amount which is effective for the purpose of said enhancement.

### DETAILED DESCRIPTION OF THE INVENTION

In a particular embodiment of the present invention, there is provided a method for enhancing the antioxidative protection afforded to a meat product by at least one substance selected from ascorbic acid, isoascorbic acid and their non-toxic water-soluble salts, inhibiting the formation of undesired toxic substances, and stabilization of myoglobin in said product, which comprises treating the meat product with an effective amount of the composition of the invention, which is an aqueous solution comprising components (1) and (2). Preferably, component (2) is selected from ascorbic acid and its non-toxic salts, and the concentrations in the solution of components (1) and (2) is such that the meat product after treatment contains 20-40 ppm sodium rosmarinate and 150-750 ppm component (2).

In another embodiment of the present invention, there is provided a method for enhancing the antioxidative protection afforded by at least one substance selected from ascorbic acid, isoascorbic acid and their non-toxic water-soluble salts, while inhibiting the formation of undesired toxic substances, in an edible oil or fat, or in a foodstuff which comprises an edible oil or fat, which comprises treating said oil, fat or foodstuff with an effective amount of the composition which is an emulsion comprising components (1) and (2), together with at least one non-toxic oil and at least one non-toxic emulsifying agent. Preferably, the weight ratio range of component (1) to component (2) in this embodiment of the invention is about 1:5 to about 1:15.

In yet another embodiment of the present invention, there is provided a method for enhancing inhibition of microbial deterioration provided by at least one ingredient selected from citric acid and its non-toxic salts, non-toxic water soluble salts of acetic and lactic acids, and non-toxic salts of propionic acid, in items selected from meat products, bakery products and other foodstuffs, while simultaneously providing antioxidative protection to these items, which comprises treating them with an effective amount of the composition which is an aqueous solution comprising components (1) and (3) or an admixture of (1) and (4). Preferably, the weight ratio range of component (1) to component (3) or (4) in this embodiment of the invention is about 1:100 to about 1:500.

The present invention further provides edible oils and fats, fatty and non-fatty meat products and plant proteins, and foodstuffs other than meat comprising an edible oil or fat, which incorporate: a completely water-soluble antioxidant containing sodium rosmarinate which is an extract of plant tissue of the Labiatae family; and at least one ingredient selected from ascorbic acid, isoascorbic acid and their non-toxic water-soluble salts; provided that the weight ratio of sodium rosmarinate to component (2) is within the range of about 1:1.5 to about 1:90.

The edible oils and fats include inter alia soybean oil and other plant oils, fish oils, margarine and butter. Plant proteins include e.g. soybean proteins.

The present invention further provides meat products and other foodstuffs, which incorporate: a completely water-soluble antioxidant containing sodium rosmarinate which is an extract of plant tissue of the Labiatae family; and at least one ingredient selected from citric acid and its non-toxic salts, and non-toxic water soluble salts of acetic, citric and lactic acids.

While any completely water-soluble extract of plant tissue of the Labiatae family may be utilized in accordance with the invention, and without prejudice to the generality of the invention, it is presently preferred to use such an extract derived from Origanum vulgare as described in the following examples. This extract, when standardized to contain about 3-8% (e.g. about 4-7%) sodium rosmarinate, then contains also about 14-17% (e.g. about 15-16%) other phenolic compounds.

The invention will now be illustrated by the following non-limiting examples.

### EXAMPLE 1

### Treatment of Meat Products with Ascorbic Acid and Sodium Rosmarinate in Aqueous Solution

(a) An aqueous antioxidant solution (“Origanox™ WS”) was prepared by aqueous extraction of oregano leaf tissue by the procedure described in U.S. Pat. No. 6,383,543 and its concentration was adjusted to an average content of 6.5 wt. % active antioxidant (sodium rosmarinate).
(b) A concentrated aqueous solution of ascorbic acid_was prepared and thoroughly mixed with the product solution of part (a), above, in an amount determined by the desired ratio of ascorbic acid_to sodium rosmarinate in the treated meat product; examples (designated “Origanox™ WS-A”) are such solutions containing on a dry basis, and calculated in relation to the weight of the treated meat product, (i) 32.5 ppm sodium rosmarinate and 250 ppm ascorbic acid, or (ii) 32.5 ppm sodium rosmarinate and 500 ppm ascorbic acid.

(c) Fresh beef was treated, by injection, with “Origanox™ WS-A” (b)(i), above. The thus-treated fresh beef product contained approximately 32.5 ppm sodium rosmarinate and 250 ppm ascorbic acid. The product was tested for myoglobin stabilization by measuring absorption, i.e. intensity of color, at 542 nm, after seven days. The results, compared with control (no additive), or using only ascorbic acid, are as follows:

| treatment | absorption at 542 nm |
|---|---|
| control | 0.243 |
| 250 ppm ascorbic acid | 0.513 |
| 250 ppm ascorbic acid + 32.5 ppm | 0.675 |
| sodium rosmarinate | |

These results show that the addition of sodium rosmarinate in aqueous solution improved preservation of the red color of meat afforded by sodium ascorbate.

(d) Cured beef was treated with “Origanox™ WS-A” (b(ii), above). The thus-treated cured beef product contained approximately 32.5 ppm sodium rosmarinate and 500 ppm ascorbic acid. The higher proportion of ascorbic acid in this case was to inhibit the formation of toxic nitrosamines. The product was tested for freshness as evidenced by the formation of malondialdehyde after 1, 4 and 7 days, and compared with control (no treatment) and with other treatments. The results are as follows:

| | Formation of malondialdehyde | | |
|---|---|---|---|
| | (mg/kg) | | |
| Treatment | day 1 | day 4 | day 7 |
| control | 1.075 | 2.067 | 2.216 |
| 32.5 ppm sodium rosmarinate | 0.798 | 1.097 | 1.327 |
| 500 ppm ascorbic acid | 0.788 | 1.224 | 1.944 |
| 500 ppm ascorbic acid + 32.5 ppm | 0.702 | 1.001 | 1.228 |
| sodium rosmarinate | | | |
| 500 ppm Herbalox ™ HT-W | 0.681 | 1.065 | 1.708 |
| 500 ppm ascorbic acid + 500 ppm | 0.67 | 1.054 | 1.654 |
| Herbalox ™ HT-W | | | |

(Herbalox ™ HT-W is a proprietary Rosemary extract of Kalsec ™ Inc.)

The above results show that the inventive combination of 500 ppm ascorbic acid+32.5 ppm sodium rosmarinate significantly lowered deterioration of cured beef especially over a 4-7 day period, and that this combination is markedly better, in this respect, than both 32.5 ppm sodium rosmarinate or 500 ppm ascorbic acid, or a combination analogous to the present one but where sodium rosmarinate (32.5 ppm) is replaced by Rosemary extract (500 ppm).

It is noted that the amounts of ascorbic acid in Example 1, parts (c) and (d) above, represent a significant reduction from the present usage levels of 1000-1500 ppm.

### EXAMPLE 2

### Treatment of Foodstuffs with Ascorbic Acid and Sodium Rosmarinate in Emulsion

(a) An emulsion designated “Origanox™ OS-A” was prepared by mixing Origanox™ WS (see Example 1(a), above) with an aqueous solution of ascorbic acid and water, and homogenizing the product with canola oil, PGPR and SPAN 80, the ingredients being present in such quantities that the resultant emulsion has the following formula:

| Ingredient | parts by weight |
|---|---|
| Origanox ™ WS | 10 |
| Ascorbic acid | 5 |
| Water | 20 |
| Polyglycerol polyricinoleate (PGPR) | 5 |
| SPAN 80 (Sorbitan monooleate) | 5 |
| Canola Oil | 55 |

The product emulsion (100 pbw) contains ascorbic acid (5 pbw) and sodium rosmarinate (0.67 pbw) in an approximate ratio of 7.7:1.

(b) Inhibition of oxidative deterioration in fried chips was determined by dissolving Origanox™ OS-A, or rosemary oil, in the frying oil (sunflower oil) and determining the amount of hexanal formed in the product (fried chips), compared with a control in which no antioxidant was used. The results were as follows:

| Antioxidant | Concentration | % Inhibition |
|---|---|---|
| Control | 0 | 0 |
| Rosemary Oil | 0.1% | 20 |
| Rosemary Oil | 0.2% | 58 |
| Origanox ™ OS-A | 0.1% | 32 |
| Origanox ™ OS-A | 0.2% | 67 |

These results show that Origanox™ OS-A gave better results than rosemary oil, in the inhibition of oxidative deterioration in fried chips.

(c) Inhibition of oxidative deterioration in soybean oil at 180° C. (four hours) was determined by dissolving Origanox™ OS-A, rosemary oil or TBHQ in the soybean oil and determining the amount of hexanal and trans-decadienal formed in the product, compared with a control in which no antioxidant was used. The results were as follows:

| Antioxidant | Concentration | % Inhibition |
|---|---|---|
| Control | 0 | 0 |
| Rosemary Oil | 0.1% | 16 |
| TBHQ | 0.02% | 32 |
| Origanox ™ OS-A | 0.1% | 38 |

These results show that Origanox™ OS-A gave better results than both rosemary oil and TBHQ, in the inhibition of oxidative deterioration in soybean oil at 180° C. In a similar experiment, it was determined that 0.075% Origanox™ OS-A extended the life of soybean oil at 180° C. by 26%, whereas 0.075% rosemary oil extended its life by 14%.

### EXAMPLE 3

### Treatment of Fresh Around Turkey Meat with Origanox™ OS-A for Delaying Oxidation, as Measured by Malondialdehyde (mg/kg)

This was carried out similarly to Example 1, except that instead of Origanox™ WS, there was used Origanox™ OS-A. The results were as follows:

| Antioxidant | Day 1 | Day 7 | Dosing |
|---|---|---|---|
| Control | 0.48 | 1.06 | |
| Rosemary Oil (Kalsec ™ Type O) | 0.41 | 0.53 | 0.2% |
| Origanox ™ OS-A | 0.36 | 0.39 | 0.15% |

The results show that Origanox™ OS-A is superior to rosemary oil in delaying oxidation both at day 1 and at day 7.

### EXAMPLE 4

### Inhibition of Salmonella Growth by a Combination of Sodium Rosmarinate and Sodium Acetate

The inhibition of salmonella growth was determined for the title combination and this was compared with control (absence of inhibitors) and using separately, sodium rosmarinate and sodium acetate. The results are as follows, comparing the inhibition of growth effect of inhibitors, control growth being taken arbitrarily at 8 hours, as 100%:

| | % Growth | |
|---|---|---|
| Inhibitor | 4 hours | 8 hours |
| Control | 83 | 100 |
| Origanox ™ WS 0.05%* | 67 | 75 |
| Sodium acetate 1.0% | 33 | 75 |
| Sodium acetate 2.0% | 17 | 62 |
| Origanox ™ WS 0.05%* + Sodium acetate 1.0% | 17 | 62 |
| Origanox ™ WS 0.05%* + Sodium acetate 2.0% | 0 | 40 |

*equivalent to 0.00325% sodium rosmarinate

These results show a remarkable synergistic effect, in that Origanox™ WS 0.05% (sodium rosmarinate 0.00325%)+sodium acetate 1% combination achieves a substantially identical antibacterial effect as when sodium acetate 2% is used by itself, while additionally, when using Origanox™ WS 0.05% (sodium rosmarinate 0.00325%)+sodium acetate 2% in combination, the results are significantly better than when using sodium acetate 2% alone.

### EXAMPLE 5

### Inhibition of Microbial Growth with Simultaneous Antioxidant Effect by a Sodium Rosmarinate+Potassium Acetate Lactate Combination

A solution containing in combination Origanox™ WS 0.05% (sodium rosmarinate 0.00325%)+potassium acetate-lactate combination (containing 40-43% potassium lactate and 17-19% potassium acetate) 1.0% was used to treat Romanian Pastrami. After one month, it was found that the level of oxidation, measured by mg/kg malondialdehyde formation, was 32% lower than control (2% potassium acetate-lactate combination), microbial growth was inhibited at the same level as the control. The potassium acetate-lactate 2.0%, was found not to provide effective protection against oxidation. The microbial count checked referred to a total count of coliform bacteria, staph. aureus, lactobacillus, molds and fungi.

### EXAMPLE 6

### Inhibition of Bacterial Growth by a Combination of Sodium Rosmarinate and a Sodium Citrate based Antibacterial

A shelf life of 18 days for a poultry product could be achieved by dosing with 0.75% of a proprietary antibacterial consisting of sodium citrate (98%) and sodium diacetate (2%), but at this level of antibacterial, the product was organoleptically unacceptable. By using instead, a combination of 0.5% antibacterial with 0.05% Origanox™ WS, it was found that the same shelf life could be achieved, while at the same time the product was organoleptically acceptable.

### EXAMPLE 7

### Improvement by Sodium Rosmarinate of Protection of Whole Wheat Flour against Mold by Calcium Propionate

Whole wheat flour which contained 22% moisture was maintained at a temperature of 30° C. The deterioration due to mold formation was measured by determining the amount (%) of carbon dioxide which formed over a ten day period or until the maximum of 15-16% was attained, whichever was the sooner. The Table shows results for control (no calcium propionate), with 0.2% added calcium propionate, and with 0.2% added calcium propionate plus 0.1% Origanox™ WS.

TABLE
Deterioration due to mold measured by carbon dioxide formation in whole wheat flour

| | Day | | | | | | | | | | |
|---|---|---|---|---|---|---|---|---|---|---|---|
| | 0 | 1 | 2 | 3 | 4 | 5 | 6 | 7 | 8 | 9 | 10 |
| Control | 0.48 | 1.60 | 2.1 | 4.2 | 13.8 | 15.5 | 15.5 | 15.4 | 15.5 | | |
| 0.2% Ca propionate | 0.54 | 0.81 | 1.1 | 1.3 | 2.0 | 3.2 | 6.5 | 14.6 | 15 | | |
| 0.2% Ca propionate + | 0.49 | 0.79 | 1.1 | 1.5 | 1.9 | 2.7 | 4.1 | 7.1 | 10.1 | 13.8 | 14.7 |
| 0.1% Origanox ™WS | | | | | | | | | | | |

These results showed inter alia that without any additive, the flour reached maximum deterioration after five days. With 0.2% added calcium propionate there was little deterioration for the first three days, after which the % carbon dioxide increased until a maximum was reached at 7-8 days. The effect of adding 0.2% calcium propionate plus 0.1% Origanox™ WS was that deterioration was significantly lower than when using 0.2% added calcium propionate alone, on days 5-9, and did not reach a maximum until after 10 days. It may therefore be concluded that at the concentrations shown in the Table, sodium rosmarinate improved the protection imparted to whole wheat flour against deterioration due to mold.

While particular embodiments of the invention have been particularly described hereinabove, it will be appreciated that the present invention is not limited thereto, since as will be readily apparent to skilled persons, many modifications or variations can be made. Such modifications or variations which have not been detailed herein are deemed to be obvious equivalents of the present invention.

1. A composition which comprises component (1) and at least one of components (2), (3) and (4). namely: (1) a completely water-soluble antioxidant containing sodium rosmarinate which is an extract of plant tissue of the Labiatae family; (2) at least one ingredient selected from ascorbic acid, isoascorbic acid and their non-toxic water-soluble salts; (3) at least one ingredient selected from citric acid and its non-toxic salts, and non-toxic water soluble salts of acetic and lactic acids; (4) at least one ingredient selected from non-toxic salts of propionic acid, provided that when component (2) is present, then sodium rosmarinate is present in said composition in an amount effective to enhance the antioxidative protection afforded by component (2) while inhibiting the formation of undesired toxic substances, in an edible oil or fat, or in a foodstuff which comprises an edible oil or fat, or in a meat product, and the weight ratio of sodium rosmarinate to component (2) is within the range of about 1:1.5 to about 1:90; and when component (3) and(or) component (4) is present, then sodium rosmarinate is present in said composition in an amount effective to enhance inhibition of microbial deterioration provided by component (3) and(or) component (4) in items selected from meat products, flour and bakery products, and other foodstuffs, and the weight ratio of component (1) to component (3) or (4) independently, is in the range is about 1:100 to about 1:500.

2. A composition according to claim 1, wherein component (2) is present, and said weight ratio range is about 1:3 to about 1:50.

3. A composition according to claim 1, which is in the solid state.

4. A composition according to claim 1, which is an aqueous solution comprising components (1) and (2).

5. A composition according to claim 1, which is an emulsion comprising components (1) and (2), together with water and at least one non-toxic oil and at least one non-toxic emulsifying agent.

6. A composition according to claim 1, which is an aqueous solution comprising components (1) and (3).

7. A composition according to claim 1, which is an admixture comprising components (1) and (4).

8. A method for enhancing the antioxidative protection afforded to a meat product by at least one substance selected from ascorbic acid, isoascorbic acid and their non-toxic water-soluble salts, inhibiting the formation of undesired toxic substances, and stabilization of myoglobin in said product, which comprises treating the meat product with an effective amount of the aqueous solution comprising components (1) and (2), as defined in claim 4.

9. A method according to claim 8, wherein component (2) is selected from ascorbic acid and its non-toxic salts, and the concentrations in said solution of components (1) and (2) is such that the meat product after treatment contains 20-40 ppm sodium rosmarinate and 150-750 ppm component (2).

10. A method for enhancing the antioxidative protection afforded by at least one substance selected from ascorbic acid, isoascorbic acid and their non-toxic water-soluble salts, while inhibiting the formation of undesired toxic substances, in an edible oil or fat, or in a foodstuff which comprises an edible oil or fat, which comprises treating said oil, fat or foodstuff with an effective amount of the emulsion comprising components (1) and (2), as defined in claim 5.

11. A method according to claim 10, wherein the weight ratio of sodium rosmarinate to component (2) in the emulsion is within the range of about 1:5 to about 1:15.

12. A method for enhancing inhibition of microbial deterioration provided by at least one ingredient selected from citric acid and its non-toxic salts, and non-toxic water soluble salts of acetic and lactic acids, citric acid and non-toxic salts of propionic acid, in items selected from meat products, flour and bakery products, and other foodstuffs, while simultaneously providing antioxidative protection therefore, which comprises treating the items with an effective amount of the aqueous solution comprising components (1) and (3) as defined in claim 6, or the admixture comprising components (1) and (4) as defined in claim 7.

13. A method according to claim 12, wherein the weight ratio of component (1) to component (3) or (4), is in the range is about 1:100 to about 1:500.

14. A member of the group consisting of edible oils and fats, fatty and non-fatty meat products and plant proteins, and foodstuffs other than meat comprising an edible oil or fat, which incorporates:
a completely water-soluble antioxidant containing sodium rosmarinate which is an extract of plant tissue of the Labiatae family; and
at least one ingredient selected from ascorbic acid, isoascorbic acid and their non-toxic water-soluble salts;
provided that the weight ratio of sodium rosmarinate to said at least one ingredient is within the range of about 1:1.5 to about 1:90.

15. A member of the group consisting of meat products, bakery products and other foodstuffs, which incorporates:
a completely water-soluble antioxidant containing sodium rosmarinate which is an extract of plant tissue of the Labiatae family; and
at least one ingredient selected from citric acid and its non-toxic salts, non-toxic water soluble salts of acetic and lactic acids, and non-toxic salts of propionic acid.

16. A method for enhancement of the preservative activity in a foodstuff of a known additive selected from the group consisting of carboxylic acids and non-toxic salts thereof, which comprises adding to the foodstuff, in addition to said known additive, a completely water-soluble antioxidant extract of plant tissue of the Labiatae family containing sodium rosmarinate, in an amount which is effective for the purpose of said enhancement.
